(19) United States
(12) Patent Application Publication
(10) Pub. No.: US 2021/0287445 A1
(43) Pub. Date: Sep. 16, 2021

(54) IMAGE SYNTHESIS APPARATUS

(71) Applicant: Panasonic Intellectual Property Management Co., Ltd., Osaka (JP)

(72) Inventor: Koji SATO, Osaka (JP)

(73) Assignee: Panasonic Intellectual Property Management Co., Ltd., Osaka (JP)

(21) Appl. No.: 17/191,176

(22) Filed: Mar. 3, 2021

(30) Foreign Application Priority Data
Mar. 10, 2020 (JP) 2020-040749
Sep. 7, 2020 (JP) 2020-149525

(51) Int. Cl. G06T 19/00; H04N 7/18; H04N 5/232; B60R 1/00

(52) U.S. Cl. CPC G06T 19/006; H04N 7/181; H04N 5/23293; B60R 2300/303; G06T 2219/028; B60R 2300/107; B60R 1/00

(57) ABSTRACT

An image synthesis apparatus includes a rearward camera for capturing a central rearward area relative to a vehicle, a left camera for capturing a left rearward area relative to the vehicle, a right camera for capturing a right rearward area relative to the vehicle, and an image synthesizer that synthesizes a central-rearward-area image captured by the rearward camera, a left-rearward-area image captured by the left camera, and a right-rearward-area image captured by the right camera to generate a rearward-area image showing the whole of the central, left, and right rearward areas relative to the vehicle. When a predetermined condition is met, the image synthesizer further generates a superimposed image in which a computer graphics (CG) image showing the vehicle is superimposed on the rearward-area image and increases the transparency of at least a part of the CG image as time elapses.

### CROSS REFERENCE TO RELATED APPLICATIONS

The present application is based on and claims priority of Japanese Patent Application No. 2020-040749 filed on Mar. 10, 2020 and Japanese Patent Application No. 2020-149525 filed on Sep. 7, 2020.

### FIELD

The present disclosure relates to an image synthesis apparatus.

### BACKGROUND

In known electronic mirrors (see, for example, Japanese Patent No. 5115136), a camera fixed to, for example, the rear bumper of a vehicle captures an area behind the vehicle, and a rearward-area image captured by the camera is displayed on a rear-view-mirror-shaped display provided inside the vehicle. To reproduce the view of an area behind a vehicle projected onto a conventional physical rear-view mirror, the electronic mirror disclosed in Japanese Patent No.

5115136 superimposes, on a rearward-area image, a vehicle image showing, for example, the rear seats and pillars of a vehicle.

### CITATION LIST

### Patent Literature

PTL 1: Japanese Patent No. 5115136

### SUMMARY

However, the conventional electronic mirrors described above can be improved upon.

In view of this, the present disclosure provides an image synthesis apparatus capable of improving upon the above conventional electronic mirrors.

An image synthesis apparatus according to one embodiment of the present disclosure includes: a rearward camera for capturing a central rearward area relative to a vehicle; a left camera for capturing a left rearward area relative to the vehicle; a right camera for capturing a right rearward area relative to the vehicle; and an image synthesizer that synthesizes a central-rearward-area image captured by the rearward camera, a left-rearward-area image captured by the left camera, and a right-rearward-area image captured by the right camera to generate a rearward-area image showing the whole of the central, left, and right rearward areas relative to the vehicle. When a predetermined condition is met, the image synthesizer further generates a superimposed image in which a computer graphics (CG) image showing the vehicle is superimposed on the rearward-area image and increases the transparency of at least a part of the CG image as time elapses.

It should be noted that a comprehensive embodiment or each of specific embodiments may be a system, method, integrated circuit, computer program, or recording medium, such as computer-readable compact disc-read only memory (CD-ROM), or may be a given combination of the system, method, integrated circuit, computer program, and recording medium.

An image synthesis apparatus according to one embodiment of the present disclosure is capable of improving upon the above conventional electronic mirrors.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 illustrates an example of a vehicle including an image synthesis apparatus according to Embodiment 1.

FIG. 2 illustrates an example of a rearward-area image that is a synthesized image obtained by the image synthesis apparatus according to Embodiment 1.

FIG. 3 is a block diagram illustrating a functional configuration of the image synthesis apparatus according to Embodiment 1.

FIG. 4 is a flowchart illustrating a procedure of operation of the image synthesis apparatus according to Embodiment 1.

FIG. 5 illustrates examples of superimposed images according to Embodiment 1.

FIG. 6 illustrates an example of a superimposed image according to Variation 2 of Embodiment 1.

FIG. 7 illustrates an example of a superimposed image according to Variation 3 of Embodiment 1.

FIG. 8 is a block diagram illustrating a functional configuration of an image synthesis apparatus according to Embodiment 2.

FIG. 9 illustrates examples of superimposed images according to Embodiment 2.

FIG. 10 is a block diagram illustrating a functional configuration of an image synthesis apparatus according to Embodiment 3.

FIG. 11 is a flowchart illustrating a procedure of operation of the image synthesis apparatus according to Embodiment 3.

FIG. 12 illustrates examples of superimposed images according to Embodiment 3.

### DESCRIPTION OF EMBODIMENTS

### (Underlying Knowledge Forming the Basis of the Present Disclosure)

The inventor of the present disclosure found the following issues in the image synthesis apparatus described in Background.

In recent years, an electronic mirror has been presented that enables a display to display a rearward-area image showing the whole of the central, left, and right rearward areas relative to a vehicle. To generate the rearward-area image, multiple cameras fixed to the vehicle capture the central, left, and right rearward areas relative to the vehicle. Then, a central-rearward-area image, left-rearward-area image, and right-rearward-area image captured by the respective cameras are synthesized.

However, compared with a conventional physical rear-view mirror, in this type of electronic mirror, a rearward area relative to a vehicle that appears in a rearward-area image covers a larger area. Thus, it may be difficult for a driver to recognize the positional relationship between the vehicle and the rearward area relative to the vehicle that appears in the rearward-area image, which is considered an issue.

Hence, application of the technique disclosed in Japanese Patent No. 5115136 to this type of electronic mirror is considered. However, the ratio of a vehicle image to a rearward-area image increases with increasing coverage of the rearward area relative to a vehicle that appears in the rearward-area image. Consequently, the vehicle image may hide a large part of the rearward-area image, and the visibility of the rearward-area image may decrease, which is considered an issue.

In view of the foregoing, an image synthesis apparatus according to one embodiment of the present disclosure includes: a rearward camera for capturing a central rearward area relative to a vehicle; a left camera for capturing a left rearward area relative to the vehicle; a right camera for capturing a right rearward area relative to the vehicle; and an image synthesizer that synthesizes a central-rearward-area image captured by the rearward camera, a left-rearward-area image captured by the left camera, and a right-rearward-area image captured by the right camera to generate a rearward-area image showing the whole of the central, left, and right rearward areas relative to the vehicle. When a predetermined condition is met, the image synthesizer further generates a superimposed image in which a computer graphics (CG) image showing the vehicle is superimposed on the rearward-area image and increases the transparency of at least a part of the CG image as time elapses.

In this embodiment, when the predetermined condition is met, the image synthesizer generates a superimposed image in which the CG image showing the vehicle is superimposed on the rearward-area image. Thus, the driver can readily recognize the positional relationship between the vehicle and the rearward area relative to the vehicle that appears in the rearward-area image. This is so despite the fact that the rearward area relative to the vehicle that appears in the rearward-area image covers a larger area compared with when a conventional physical rear-view mirror is used. In addition, the image synthesizer increases the transparency of at least a part of the CG image as time elapses. This can suppress the CG image from obstructing the user's view of the rearward-area image, which can enhance the visibility of the rearward-area image.

For instance, the predetermined condition may be at least one of the following conditions: that the ignition switch of the vehicle is switched on, that the operation switch of the vehicle receives an instruction from a user to display the superimposed image on a display, and that the vehicle in a stationary state starts moving.

In this embodiment, the superimposed image can be displayed on the display at a timing when the user is usually likely to check the area behind the vehicle (when the user switches on the ignition switch of the vehicle or when the stationary vehicle starts moving). In another case, the superimposed image can be displayed on the display at a timing when the user wants to check the area behind the vehicle (when the operation switch of the vehicle receives an instruction from the user to display the superimposed image on the display). This can improve usability for users.

For instance, when a predetermined period of time has elapsed since the predetermined condition was met, the image synthesizer may stop changing the transparency of the at least a part of the CG image.

In this embodiment, a relatively high transparency level can be maintained for the at least a part of the CG image superimposed on the rearward-area image, which can enhance the visibility of the rearward-area image while enabling the user to recognize the positional relationship between the vehicle and the rearward area relative to the vehicle that appears in the rearward-area image.

For instance, the predetermined period of time may be settable by a user.

In this embodiment, it is possible to stop changing the transparency of the at least a part of the CG image at a user's preferred timing after the predetermined condition is met.

For instance, the transparency of the at least a part of the CG image may be settable by a user, the transparency being transparency when the predetermined period of time has elapsed since the predetermined condition was met.

In this embodiment, the transparency, when the predetermined period of time has elapsed since the predetermined condition was met, of the at least a part of the CG image superimposed on the rearward-area image is settable to a user's preferred transparency level.

For instance, the image synthesizer may be capable of changing a virtual viewpoint between a first viewpoint and a second viewpoint and generate the CG image based on the virtual viewpoint, the virtual viewpoint being a viewpoint from which the vehicle to be shown by the CG image is viewed, the first viewpoint being a viewpoint at which a front portion of the vehicle is viewed externally from above, and the second viewpoint being a viewpoint at which an area behind the vehicle is viewed horizontally from the driver's seat of the vehicle.

In this embodiment, it is possible to change the virtual viewpoint between the first viewpoint and the second viewpoint, which can enhance the visual effects of the CG image.

For instance, when the predetermined condition is met, the image synthesizer may superimpose the CG image on the rearward-area image while changing the virtual viewpoint from the first viewpoint to the second viewpoint with elapse of time to generate the superimposed image.

In this embodiment, the virtual viewpoint is changed from the first viewpoint to the second viewpoint as time elapses, which can further improve the visual effects of the CG image.

For instance, the virtual viewpoint may be settable by a user. In this embodiment, the CG image generated based on the user's preferred virtual viewpoint can be superimposed on the rearward-area image.

For instance, the predetermined condition may be that a traveling object does not appear in the rearward-area image or that the vehicle is stationary and a stationary object does not appear in the rearward-area image.

In this embodiment, if a traveling object appears in the rearward-area image, the CG image will not be superimposed, which can decrease the possibility of the CG image hiding the traveling object. In addition, if the vehicle is stationary, and a stationary object appears in the rearward-area image, the CG image will not be superimposed. Thus, it is possible to decrease the possibility of the CG image hiding the object that is stationary, for example, at a red light. This enables a higher level of safety in terms of checking the rear.

For instance, if a traveling object appears in the rearward-area image, the image synthesizer may detect the position and size of the object, remove or simplify a part of the CG image in the superimposed image, and superimpose the CG image that has been partially removed or simplified on the rearward-area image, the part of the CG image being located at the position of the object and having a size equivalent to at least the size of the object.

In this embodiment, if a traveling object appears in the rearward-area image, the CG image is displayed except on a part of the rearward-area image showing the traveling object. Thus, the driver (user) can recognize the traveling object that might have been hidden by the CG image while having spatial awareness of the surrounding environment of the vehicle.

For instance, during operation of the direction indicator of the vehicle, the image synthesizer superimposes, on the rearward-area image, at least one of the two halves of the CG image split by the center line in a transverse direction of the CG image, the one of the two halves corresponding to a direction opposite to a direction indicated by the direction indicator.

In this embodiment, one of the two halves of the CG image corresponding to the turn direction is not superimposed on the rearward-area image. Thus, when the vehicle turns right or left or changes lanes, it is possible to decrease the possibility of the CG image hiding an object present in the direction. On the other hand, at least the other of the two halves of the CG image corresponding to the direction opposite to the turn direction is superimposed on the rearward-area image. This enables the driver (user) to have spatial awareness of their surrounding environment.

It should be noted that a comprehensive embodiment or each of specific embodiments may be a system, method, integrated circuit, computer program, or recording medium, such as computer-readable CD-ROM, or may be a given combination of the system, method, integrated circuit, computer program, and recording medium.

Hereinafter, the embodiments are described in detail with reference to the accompanying drawings.

It should be noted that each embodiment described below is a comprehensive or specific example. The numerical values, shapes, materials, structural elements, arrangements and connections of the structural elements, steps, and order of the steps, and others described in the embodiments below are provided as examples and are not intended to limit the present disclosure. Moreover, among the structural elements described in the embodiments below, the structural elements not included in the independent claims, which represent superordinate concepts, are described as optional structural elements.

### Embodiment 1

### [1-1. Overview of Image Synthesis Apparatus]

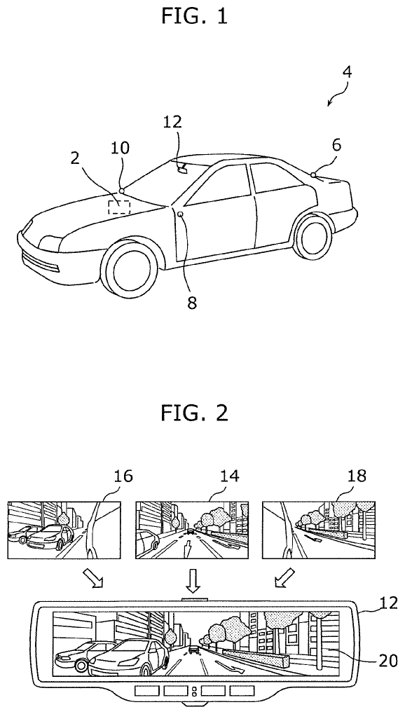

With reference to FIGS. 1 and 2, the overview of image synthesis apparatus 2 according to Embodiment 1 is described below. FIG. 1 illustrates an example of vehicle 4 including image synthesis apparatus 2 according to Embodiment 1. FIG. 2 illustrates an example of rearward-area image 20 that is a synthesized image obtained by image synthesis apparatus 2 according to Embodiment 1.

As illustrated in FIG. 1, vehicle 4 includes rearward camera 6, left camera 8, right camera 10, image synthesis apparatus 2, and display 12. Vehicle 4 is a motor vehicle, such as a regular passenger vehicle, bus, or truck. It should be noted that vehicle 4 is not limited to a motor vehicle and may be, for example, a construction machine or agricultural machine.

Hereinafter, the direction in which vehicle 4 moves forward is referred to as forward, and the direction in which vehicle 4 moves rearward is referred to as rearward. In addition, in the direction in which vehicle 4 moves forward, the left side relative to vehicle 4 is referred to as left, and the right side relative to vehicle 4 is referred to right.

Rearward camera 6 is provided on, for example, the rear bumper or trunk hood of vehicle 4 to capture a central rearward area relative to vehicle 4. It should be noted that the central rearward area relative to vehicle 4 denotes the area directly behind vehicle 4. As illustrated in FIG. 2, rearward camera 6 generates central-rearward-area image 14 showing the central rearward area relative to vehicle 4 by capturing the central rearward area relative to vehicle 4.

Left camera 8 is provided on or near, for example, the left front door of vehicle 4 to capture a left rearward area relative to vehicle 4. It should be noted that the left rearward area relative to vehicle 4 denotes the area to the left of the area directly behind vehicle 4 in the direction in which vehicle 4 moves forward. As illustrated in FIG. 2, left camera 8 generates left-rearward-area image 16 showing the left rearward area relative to vehicle 4 by capturing the left rearward area relative to vehicle 4.

Right camera 10 is provided on or near, for example, the right front door of vehicle 4 to capture a right rearward area relative to vehicle 4. It should be noted that the right rearward area relative to vehicle 4 denotes the area to the right of the area directly behind vehicle 4 in the direction in which vehicle 4 moves forward. As illustrated in FIG. 2, right camera 10 generates right-rearward-area image 18 showing the right rearward area relative to vehicle 4 by capturing the right rearward area relative to vehicle 4.

Image synthesis apparatus 2 is provided inside vehicle 4. As illustrated in FIG. 2, image synthesis apparatus 2 generates rearward-area image 20 showing the whole of the central, left, and right rearward areas relative to vehicle 4 by synthesizing central-rearward-area image 14, left-rearward-area image 16, and right-rearward-area image 18 respectively generated by rearward camera 6, left camera 8, right camera 10. It should be noted that rearward camera 6, left camera 8, right camera 10 simultaneously capture central-rearward-area image 14, left-rearward-area image 16, and right-rearward-area image 18, which are then synthesized by image synthesis apparatus 2. Image synthesis apparatus 2 outputs a flipped image of generated rearward-area image 20 to display 12.

It should be noted that rearward camera 6, left camera 8, right camera 10 may generate flipped images from central-rearward-area image 14, left-rearward-area image 16, and right-rearward-area image 18. In this case, image synthesis apparatus 2 does not flip rearward-area image 20 horizontally. In other words, image synthesis apparatus 2 may flip rearward-area image 20 horizontally where necessary.

Display 12 is an electronic mirror for displaying rearward-area image 20 output by image synthesis apparatus 2. Display 12 is provided above the driver's seat inside vehicle 4 and used as an alternative to a conventional physical rear-view mirror for showing the area behind vehicle 4 by light reflection.

### [1-2. Functional Configuration of Image Synthesis Apparatus]

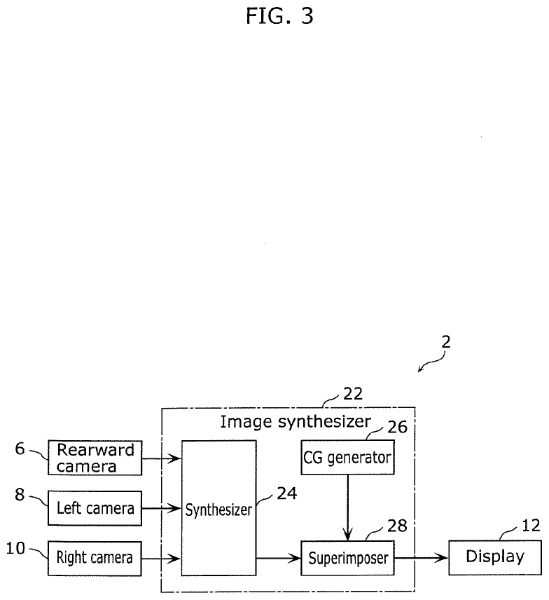

With reference to FIG. 3, a functional configuration of image synthesis apparatus 2 according to Embodiment 1 is described. FIG. 3 is a block diagram illustrating a functional configuration of image synthesis apparatus 2 according to Embodiment 1.

As illustrated in FIG. 3, as functional elements, image synthesis apparatus 2 includes rearward camera 6, left camera 8, right camera 10, image synthesizer 22, and display 12.

By capturing the central rearward area relative to vehicle 4, rearward camera 6 generates central-rearward-area image 14 showing the central rearward area relative to vehicle 4. Rearward camera 6 then outputs generated central-rearward-area image 14 to image synthesizer 22.

By capturing the left rearward area relative to vehicle 4, left camera 8 generates left-rearward-area image 16 showing the left rearward area relative to vehicle 4. Left camera 8 then outputs generated left-rearward-area image 16 to image synthesizer 22.

By capturing the right rearward area relative to vehicle 4, right camera 10 generates right-rearward-area image 18 showing the right rearward area relative to vehicle 4. Right camera 10 then outputs generated right-rearward-area image 18 to image synthesizer 22.

Image synthesizer 22 includes synthesizer 24, computer graphics (CG) generator 26, and superimposer 28.

Synthesizer 24 generates rearward-area image 20 by synthesizing central-rearward-area image 14, left-rearward-area image 16, and right-rearward-area image 18 respectively output by rearward camera 6, left camera 8, and right camera 10. Synthesizer 24 then outputs generated rearward-area image 20 to superimposer 28.

It should be noted that to generate rearward-area image 20, synthesizer 24 may cut an image of the same size as the display area of display 12 from the image obtained by synthesizing central-rearward-area image 14, left-rearward-area image 16, and right-rearward-area image 18. This can shorten the duration of time to generate rearward-area image 20. Alternatively, to generate rearward-area image 20, synthesizer 24 may synthesize three images respectively cut from central-rearward-area image 14, left-rearward-area image 16, and right-rearward-area image 18 so that the total area of the three images is identical to the size of the display area of display 12. This can save memory capacity used to generate rearward-area image 20.

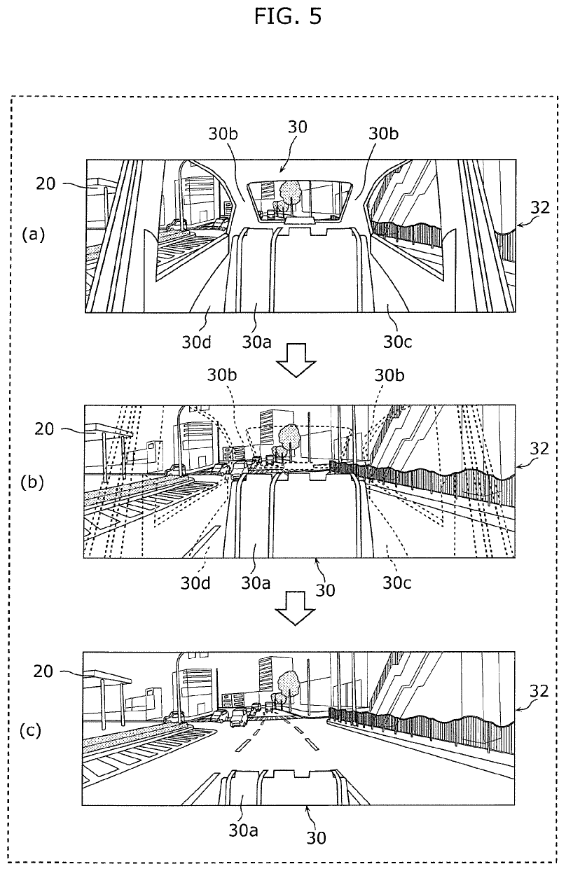

CG generator 26 generates CG image 30 (see FIG. 5 described later) showing vehicle 4 and outputs generated CG image 30 to superimposer 28. Details of CG image 30 are described later.

Superimposer 28 generates superimposed image 32 (see FIG. 5 described later) by superimposing CG image 30 output by CG generator 26 on rearward-area image 20 output by synthesizer 24. That is, superimposed image 32 is an image in which CG image 30 is superimposed on rearward-area image 20. Superimposer 28 outputs generated superimposed image 32 to display 12. It should be noted that if CG generator 26 does not generate CG image 30, superimposer 28 outputs rearward-area image 20 output by synthesizer 24 to display 12 without superimposing CG image 30.

Display 12 displays superimposed image 32 output by superimposer 28 (or rearward-area image 20 on which CG image 30 is not superimposed).

### [1-3. Operation of Image Synthesis Apparatus]

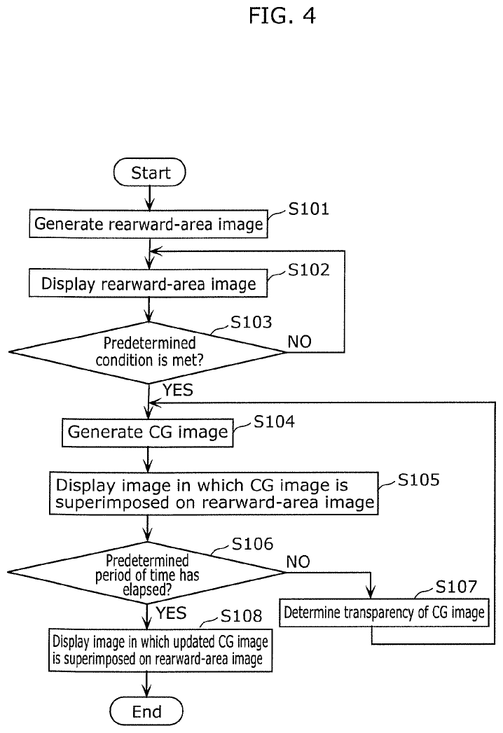

With reference to FIGS. 4 and 5, operation of image synthesis apparatus 2 according to Embodiment 1 is described. FIG. 4 is a flowchart illustrating a procedure of operation of image synthesis apparatus 2 according to Embodiment 1. FIG. 5 illustrates examples of superimposed images 32 according to Embodiment 1.

As illustrated in FIG. 4, synthesizer 24 of image synthesizer 22 generates rearward-area image 20 by synthesizing central-rearward-area image 14, left-rearward-area image 16, and right-rearward-area image 18 respectively output by rearward camera 6, left camera 8, and right camera 10 (S101). Synthesizer 24 outputs generated rearward-area image 20 to superimposer 28.

Superimposer 28 outputs rearward-area image 20 output by synthesizer 24 to display 12. This enables display 12 to display rearward-area image 20 output by superimposer 28 (S102). Here, CG image 30 is yet to be superimposed on rearward-area image 20 displayed on display 12.

Then, CG generator 26 determines whether a predetermined condition is met (S103). The predetermined condition is, for example, at least one of the following conditions: a) the ignition switch of vehicle 4 is switched on, b) the operation switch of vehicle 4 receives an instruction from a user to display superimposed image 32 on display 12, and c) stationary vehicle 4 starts moving. It should be noted that the operation switch is, for example, a physical switch disposed inside vehicle 4 or a switch on a graphical user interface (GUI) displayed on, for example, display 12.

If the predetermined condition is not met (No in S103), the procedure returns to step S102 described above, and display 12 continues to display rearward-area image 20 output by superimposer 28.

When, for instance, the ignition switch of vehicle 4 is switched on, and thus the predetermined condition is met (Yes in S103), CG generator 26 generates CG image 30 (S104) and outputs generated CG image 30 to superimposer 28. Superimposer 28 generates superimposed image 32 by superimposing CG image 30 output by CG generator 26 on rearward-area image 20 output by synthesizer 24 and then outputs generated superimposed image 32 to display 12. This enables display 12 to display superimposed image 32 output by superimposer 28 (S105).

As illustrated in (a) in FIG. 5, CG image 30 shows the interior of a passenger compartment when, for example, the central rearward area relative to vehicle 4 is viewed horizontally through a rear-view mirror from the driver's seat of vehicle 4. Specifically, CG image 30 includes, for example, CG image 30a of rear seats, CG image 30b of rear pillars, CG image 30c of the right rear door, and CG image 30d of the left rear door. It should be noted that CG image 30 does not include transparent window glasses, such as a front door glass, rear door glass, and back glass.

As illustrated in (a) in FIG. 5, immediately after the predetermined condition is met, the whole of CG image 30 is opaque with, for example, a transparency of 0%. Thus, in superimposed image 32, it is not possible to visually recognize the part of rearward-area image 20 on which CG image 30 is superimposed. By viewing CG image 30 superimposed on rearward-area image 20, a driver (example of user) can readily recognize the positional relationship between vehicle 4 and the rearward area (central, left, and right rearward areas) relative to vehicle 4 that appears in rearward-area image 20.

When a predetermined period of time (e.g., 10 seconds) has not elapsed since the predetermined condition was met (No in S106), CG generator 26 obtains the transparency of CG image 30 (S107). Specifically, CG generator 26 increases the transparency of the part of CG image 30 other than CG image 30a of the rear seats to exceed a transparency of 0%, the part including CG images 30b, 30c, and 30d. Here, CG generator 26 gradually increases the transparency of the part of CG image 30, for example, from 0% to 10% to 20% to . . . to 100%. Alternatively, CG generator 26 may continuously increase the transparency, for example, from 0% to 1% to 2% to . . . to 100%.

It should be noted that the predetermined period of time may be settable to a given period of time, for example, by the driver operating the operation switch. In this case, the predetermined period of time set by the driver may be reset every time the ignition switch of vehicle 4 is switched off or may be held until the ignition switch of vehicle 4 is switched on again once the ignition switch is switched off.

The procedure then returns to step S104, and CG generator 26 generates CG image 30 according to the changed transparency and outputs generated CG image 30 to superimposer 28. Superimposer 28 generates superimposed image 32 by superimposing CG image 30 output by CG generator 26 on rearward-area image 20 output by synthesizer 24 and then outputs generated superimposed image 32 to display 12. This enables display 12 to display superimposed image 32 output by superimposer 28 (S105).

As illustrated in (b) in FIG. 5, CG image 30a of the rear seats, which is a part of CG image 30, is still opaque with a transparency of 0%. The parts of CG image 30 other than CG image 30a of the rear seats, such as CG images 30b, 30c, and 30d, are, on the other hand, translucent with, for example, a transparency of 10%. Thus, in superimposed image 32, it is possible to visually recognize the parts of rearward-area image 20 on which CG images 30b, 30c, and 30d and others are superimposed. It should be noted that in (b) in FIG. 5, the outline of opaque CG image 30a is shown by the solid lines, and the outlines of translucent CG images 30b, 30c, and 30d and other translucent parts are shown by the dashed lines.

It should be noted that in Embodiment 1, as an example, CG image 30a of the rear seats remains opaque. However, CG image 30a is not limited to an opaque image and may be changed to a translucent image by increasing the transparency up to a predetermined transparency level (e.g., a transparency of 50%) based on, for example, the user's preference or viewability. In this case, in step S107, CG generator 26 also gradually increases the transparency of CG image 30a of the rear seats, for example, from 0% to 10% to 20% to . . . to 50%.

Then, when the predetermined period of time has not elapsed since the predetermined condition was met (No in S106), each processing of steps S107, S104, and S105 described above is performed again. The foregoing processing is repeated until the predetermined period of time has elapsed since the predetermined condition was met. Thus, CG generator 26 maintains a transparency of 0% for CG image 30a of the rear seats and increases with elapse of time the transparency of the part of CG image 30 other than CG image 30a of the rear seats from 0% to 100%, the part including CG images 30b, 30c, and 30d.

It should be noted that when rendering CG image 30a of the rear seats translucent and maintaining, for example, a transparency of 50%, CG generator 26 increases the transparency of CG image 30a of the rear seats from 0% to 50% as time elapses.

When the predetermined period of time has elapsed since the predetermined condition was met (Yes in S106), CG generator 26 stops changing the transparency of the part of CG image 30 that is the part other than CG image 30a of the rear seats and that includes CG images 30b, 30c, and 30d and maintains the transparency immediately before changing of the transparency is stopped (e.g., a transparency of 100%). It should be noted that the transparency immediately before changing of the transparency is stopped may be settable to a given transparency level, for example, by the driver operating the operation switch.

CG generator 26 outputs to superimposer 28 CG image 30 having the transparency immediately before changing of the transparency is stopped. Superimposer 28 generates superimposed image 32 by superimposing CG image 30 output by CG generator 26 on rearward-area image 20 output by synthesizer 24 and then outputs generated superimposed image 32 to display 12. This enables display 12 to display superimposed image 32 output by superimposer 28 (S108).

Here, as illustrated in (c) in FIG. 5, CG image 30a of the rear seats, which is a part of CG image 30, is opaque with a transparency of 0%. The parts of CG image 30 other than CG image 30a of the rear seats, such as CG images 30b, 30c, and 30d, are, on the other hand, transparent with a transparency of 100%. Thus, in superimposed image 32, it is possible to visually recognize the parts of rearward-area image 20 on which CG images 30b, 30c, and 30d and others are superimposed. It should be noted that (c) in FIG. 5 does not illustrate transparent CG images 30b, 30c, and 30d or other transparent parts.

This can suppress CG image 30 from obstructing the driver's view of rearward-area image 20, which can enhance the visibility of rearward-area image 20. In addition, among the parts of CG image 30, for example, only CG image 30a of the rear seats is opaque. Thus, by viewing CG image 30a of the rear seats superimposed on rearward-area image 20, the driver can readily recognize the positional relationship between vehicle 4 and the rearward area relative to vehicle 4 that appears in rearward-area image 20.

It should be noted that in (c) in FIG. 5, CG image 30a of the rear seats is lower than CG images 30a of the rear seats in (a) and (b) in FIG. 5. This is because CG images 30a in (a) and (b) in FIG. 5 may hide the central rearward area relative to vehicle 4 that appears in rearward-area image 20. However, since the width of CG image 30a of the rear seats remains the same, the driver can still recognize the positional relationship between rearward-area image 20 and vehicle 4. In addition, if a virtual viewpoint is variable as described later, and CG image 30a of the rear seats does not significantly hide rearward-area image 20 for vehicle 4, then display control to display CG image 30a of the rear seats at a lower position need not be performed.

### [1-4. Advantageous Effects]

As described above, in Embodiment 1, when the predetermined condition is met, display 12 displays superimposed image 32 in which CG image 30 is superimposed on rearward-area image 20. Thus, although the rearward area relative to vehicle 4 that appears in rearward-area image 20 covers a larger area compared with when a conventional psychical rear-view mirror is used, the driver can readily recognize the positional relationship between vehicle 4 and the rearward area relative to vehicle 4 that appears in rearward-area image 20.

In addition, until the predetermined period of time has elapsed since the predetermined condition was met, CG generator 26 increases the transparency of a part of CG image 30 as time elapses. This can suppress CG image 30 from obstructing the driver's view of rearward-area image 20, which can enhance the visibility of rearward-area image 20.

It should be noted that rearward-area image 20 in FIG. 5 illustrates a case in which vehicle 4 is stationary. However, display control for CG image 30 may be performed when vehicle 4 is traveling. In this case, rearward-area image 20 changes in real time also when display control for CG image 30 is being performed.

### [1-5. Variation 1]

In Embodiment 1, as an example, the predetermined condition is at least one of the following conditions: a) the ignition switch of vehicle 4 is switched on, b) the operation switch of vehicle 4 receives an instruction from a user to display superimposed image 32 on display 12, and c) stationary vehicle 4 starts moving. However, the predetermined condition is not limited to the above conditions and may be condition d) a traveling object does not appear in rearward-area image 20. The traveling object is, for example, another motor vehicle, a motorcycle, a bicycle, or a pedestrian that is traveling. That is, if a traveling object does not appear in rearward-area image 20, image synthesizer 22 determines that the predetermined condition is met.

In other words, when it is determined that a traveling object appears in rearward-area image 20, the predetermined condition is not met. Thus, image synthesizer 22 will not superimpose CG image 30 on rearward-area image 20. Hence, in rearward-area image 20, it is possible to decrease the possibility of CG image 30 hiding the traveling object, which enables a higher level of safety in terms of checking the rear.

In addition to conditions a) to d), the predetermined condition may be condition e) vehicle 4 is stationary and a stationary object does not appear in rearward-area image 20. The stationary object is, for example, another motor vehicle, a motorcycle, a bicycle, or a pedestrian that is stationary while vehicle 4 is stationary. That is, if a stationary object does not appear in rearward-area image 20, image synthesizer 22 determines that the predetermined condition is met.

In other words, when it is determined that a stationary object appears in rearward-area image 20, the predetermined condition is not met. Thus, image synthesizer 22 will not superimpose CG image 30 on rearward-area image 20. Hence, when vehicle 4 is stationary at a red light or for other reason, in rearward-area image 20, it is possible to decrease the possibility of CG image 30 hiding the object that is stationary at a red light or for other reason, which enables a higher level of safety in terms of checking the rear.

It should be noted that regarding the predetermined condition, conditions d) and e) described above may be combined with conditions a) to c) or given precedence over conditions a) to c).

### [1-6. Variation 2]

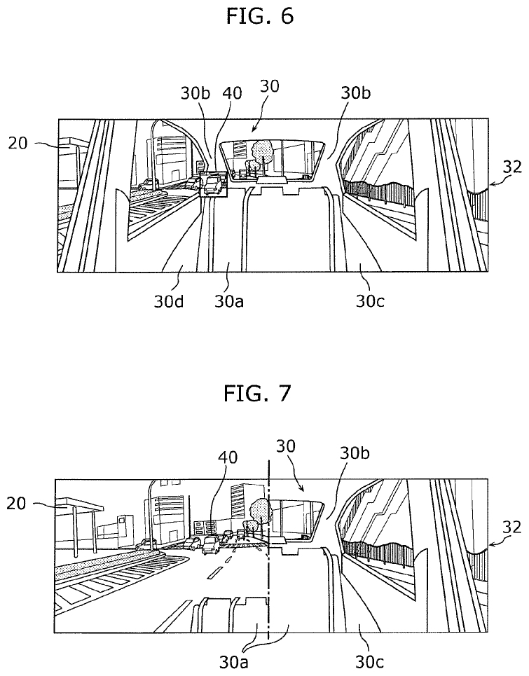

In Embodiment 1, when the predetermined condition is met, display 12 displays superimposed image 32 output by superimposer 28. In Variation 2, representation shown in FIG. 6 is provided. FIG. 6 illustrates an example of a superimposed image according to Variation 2 of Embodiment 1.

That is, as illustrated in FIG. 6, if traveling object 40 appears in rearward-area image 20, image synthesizer 22 detects the position and size of traveling object 40 in relation to rearward-area image 20. It should be noted that conventionally known various techniques are applicable to the method of detecting traveling object 40, the method being performed by image synthesizer 22. Image synthesizer 22 removes a part of CG image 30 in superimposed image 32, the part of CG image 30 being located at the position of object 40 and having a size equivalent to at least that of object 40. Image synthesizer 22 then superimposes CG image 30 that has been partially removed on rearward-area image 20. In FIG. 6, CG image 30 is not displayed on the part in which another motor vehicle (object 40) traveling behind and on the left side of vehicle 4 appears. Other representation and an operation to gradually increase the transparency of a part of CG image 30 are similar to those described in Embodiment 1.

This enables a driver to recognize the presence of the following vehicle (object 40) that CG image 30 may hide. Since CG image 30 is displayed except on the part in which object 40 appears, it is possible for the driver to have spatial awareness of the surrounding environment of the vehicle.

It should be noted that in Variation 2, in superimposed image 32, a part of CG image 30 of a size equivalent to at least that of object 40 is removed at the position of object 40, and CG image 30 that has been partially removed is superimposed on rearward-area image 20. However, the part of CG image 30 to be removed does not necessarily have to be completely removed. For instance, the part of CG image 30 of the size equivalent to that of object 40 may be simplified into wire-frame representation, and the simplified part of CG image 30 may be superimposed on rearward-area image 20.

To make the presence of object 40 more noticeable, a part of CG image 30 larger (e.g., 10% larger in the vertical direction and in the horizontal direction) than object 40 in rearward-area image 20 may be removed at the position of object 40. Then, CG image 30 that has been partially removed may be superimposed on rearward-area image 20. This enables the driver to more accurately recognize the presence of object 40.

To make the presence of object 40 more noticeable, as illustrated in FIG. 6, an enclosing line that surrounds the appearance of object 40 may be displayed. That is, the area surrounded by the enclosing line may be larger than the size of object 40. Here, representation of the enclosing line may be emphasized. For instance, the enclosing line may be red or flash, or the brightness of the enclosing line may be changed. This enables the driver to more accurately recognize the presence of object 40 especially when object 40 is a small object, such as a motorcycle, bicycle, and pedestrian.

### [1-7. Variation 3]

In Embodiment 1, when the predetermined condition is met, display 12 displays superimposed image 32 output by superimposer 28. In Variation 3, image synthesizer 22 performs display control for CG image 30 with operation of the direction indicator of vehicle 4. Details of the operation are described with reference to FIG. 7. FIG. 7 illustrates an example of a superimposed image according to Variation 3 of Embodiment 1.

When the predetermined condition is met during operation of the direction indicator of vehicle 4, image synthesizer 22 operates in the following manner. It should be noted that in Variation 3, image synthesizer 22 has the function of receiving operation information on the direction indicator from vehicle 4 through communication.

During operation of the direction indicator, image synthesizer 22 superimposes, on rearward-area image 20, one of the two halves of CG image 30 split by the center line in a transverse direction of CG image 30, the one of the two halves corresponding to a direction opposite to a turn direction indicated by the direction indicator. It should be noted that the center line corresponds to the dashed-dotted line illustrated in FIG. 7 and splits CG image 30 into the right and left parts. Specifically, in FIG. 7, if, for example, the direction indicator indicates the left direction, except CG image 30a (CG image of rear seats) that will continue to appear, the left half of CG image 30 relative to the center line in the transverse direction of CG image 30 will not be superimposed on rearward-area image 20, and only the other half, that is, the right half of CG image 30 will be superimposed on rearward-area image 20. Other representation and an operation to gradually increase the transparency of a part of CG image 30 are similar to those described in Embodiment 1.

Thus, except CG image 30a of the rear seats, the half of CG image 30 corresponding to the turn direction (left half in FIG. 7) is not superimposed on rearward-area image 20. This can decrease the possibility of CG image 30 hiding object 40 present in the turn direction (following vehicle on the left side in FIG. 7) when vehicle 4 turns right or left or changes lanes (when vehicle 4 turns left in FIG. 7). Meanwhile, the other half of CG image 30 (right half in FIG. 7) corresponding to the direction opposite to the turn direction is superimposed on rearward-area image 20, which enables the driver to have spatial awareness of the surrounding environment of the vehicle.

It should be noted that in Variation 3, except CG image 30a of the rear seats, the half of CG image 30 corresponding to the turn direction (left half in FIG. 7) is not superimposed on rearward-area image 20. However, this is a mere example. For instance, while CG image 30a of the rear seats is displayed, for example, 60 to 70% of the half of CG image 30 corresponding to the turn direction may not be superimposed on rearward-area image 20. This facilitates driver's visual checking of the rear in the turn direction. However, if the ratio of the part on which CG image 30 is not superimposed increases excessively, it will be difficult to sufficiently maintain the driver's spatial awareness of the surrounding environment of the vehicle. Thus, the percentage of the part on which CG image 30 is not superimposed may be at most 70%.

In addition, through combination of Variations 2 and 3, image synthesizer 22 may have the function of detecting object 40 described in Variation 2 and display an enclosing line surrounding the appearance of object 40 (such representation includes emphasized representation). This enables the driver to more accurately recognize object 40 in the turn direction especially when object 40 is a small object, such as a motorcycle, bicycle, and pedestrian.

In Variation 3, except CG image 30a of the rear seats, the half (left half in FIG. 7) of CG image 30 corresponding to the turn direction is not superimposed on rearward-area image 20. However, for instance, when traveling object 40 is detected as described in Variation 2, and detected object 40 overlaps CG image 30a of the rear seats, CG image 30a of the rear seats may not be displayed with operation of the direction indicator. In this case, the whole half of CG image 30 corresponding to the turn direction is not superimposed on rearward-area image 20.

Through combination of Variations 2 and 3, the following processing may be performed. If traveling object 40 is present during operation of the direction indicator, at least half of CG image 30 corresponding to a direction opposite to a direction indicated by the direction indicator may be superimposed on rearward-area image 20, and representation of object 40 may be emphasized by, for example, an enclosing line.

### Embodiment 2

### [2-1. Functional Configuration of Image Synthesis Apparatus]

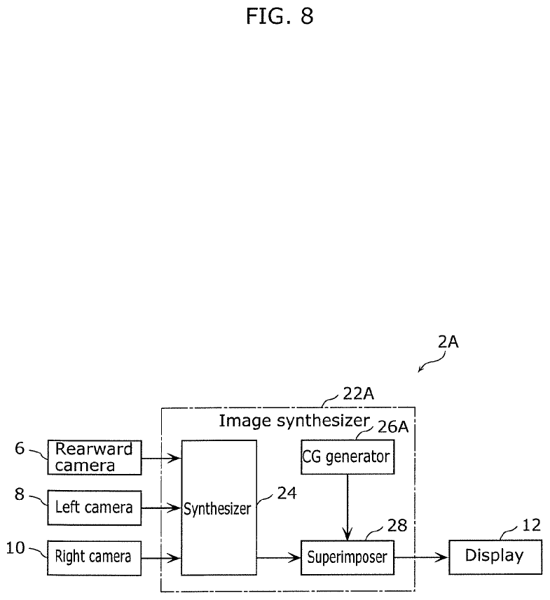

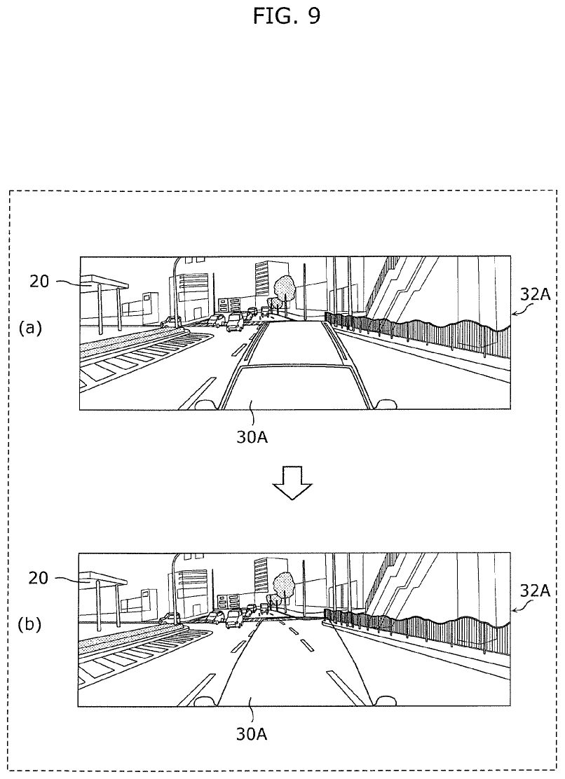

With reference to FIGS. 8 and 9, a functional configuration of image synthesis apparatus 2A according to Embodiment 2 is described. FIG. 8 is a block diagram illustrating a functional configuration of image synthesis apparatus 2A according to Embodiment 2. FIG. 9 illustrates examples of superimposed images 32A according to Embodiment 2. It should be noted that in Embodiments 2 and 3, structural elements identical to those described in Embodiment 1 are assigned the same reference symbols, and explanations for such structural elements are omitted.

Regarding image synthesis apparatus 2A according to Embodiment 2 illustrated in FIG. 8, CG image 30A generated by CG generator 26A of image synthesizer 22A differs from CG image 30 described in Embodiment 1. Specifically, as illustrated in (a) in FIG. 9, CG image 30A illustrates a front portion (front glass and its adjacent portions) of vehicle 4 (see FIG. 1) viewed, for example, externally from above.

As illustrated in (a) in FIG. 9, immediately after a predetermined condition is met, the whole of CG image 30A is opaque with, for example, a transparency of 0%, and in superimposed image 32A, it is not possible to visually recognize the part of rearward-area image 20 on which CG image 30A is superimposed. By viewing CG image 30A superimposed on rearward-area image 20, a driver can readily recognize the positional relationship between vehicle 4 and the rearward area relative to vehicle 4 that appears in rearward-area image 20.

Until a predetermined period of time has elapsed since the predetermined condition was met, CG generator 26A increases the transparency of CG image 30A (except the outline) as time elapses.

When the predetermined period of time has elapsed since the predetermined condition was met, CG generator 26A stops changing the transparency of CG image 30A (except the outline) and maintains the transparency immediately before changing of the transparency is stopped (e.g., a transparency of 100%).

At that time, as illustrated in (b) in FIG. 9, CG image 30A (except the outline) is transparent with a transparency of 100%, and thus in superimposed image 32A, it is possible to visually recognize the part of rearward-area image 20 on which CG image 30A is superimposed. The outline of CG image 30A is opaque with a transparency of 0%. It should be noted that (b) in FIG. 9 does not illustrate transparent CG image 30A (except the outline).

This can suppress CG image 30A from obstructing the driver's view of rearward-area image 20, which can enhance the visibility of rearward-area image 20. In addition, only the outline of CG image 30A (i.e., outline of vehicle 4 shown by CG image 30A) is opaque. Thus, by viewing the outline of CG image 30A superimposed on rearward-area image 20, the driver can readily recognize the positional relationship between vehicle 4 and the rearward area relative to vehicle 4 that appears in rearward-area image 20.

### [2-2. Advantageous Effects]

In Embodiment 2, as with Embodiment 1, it is possible to enhance the visibility of rearward-area image 20 while CG image 30A displayed on superimposed image 32A enables the driver to recognize the positional relationship between vehicle 4 and the rearward area relative to vehicle 4 that appears in rearward-area image 20.

It should be noted that as with FIG. 5, rearward-area image 20 in FIG. 9 illustrates a case in which vehicle 4 is stationary. However, display control for CG image 30A may be performed when vehicle 4 is traveling. In this case, rearward-area image 20 changes in real time also when display control for CG image 30A is being performed.

### Embodiment 3

### [3-1. Functional Configuration of Image Synthesis Apparatus]

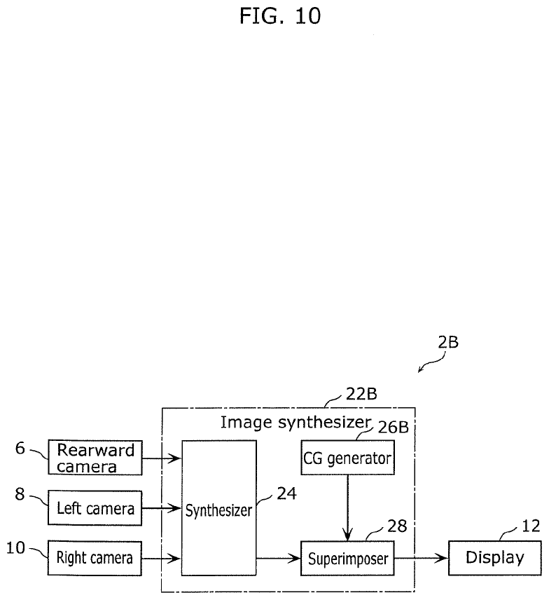

With reference to FIG. 10, a functional configuration of image synthesis apparatus 2B according to Embodiment 3 is described. FIG. 10 is a block diagram illustrating a functional configuration of image synthesis apparatus 2B according to Embodiment 3.

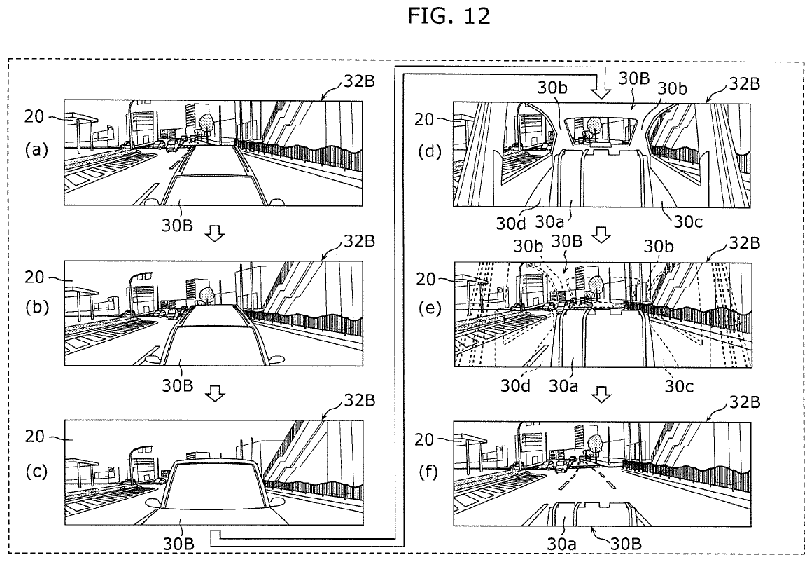

Regarding image synthesis apparatus 2B according to Embodiment 3 illustrated in FIG. 10, CG image 30B (see FIG. 12 described later) generated by CG generator 26B of image synthesizer 22B differs from CG image 30 described in Embodiment 1.

Specifically, CG generator 26B can change a virtual viewpoint between a first viewpoint (viewpoint outside the vehicle) and a second viewpoint (viewpoint inside the vehicle). The virtual viewpoint is a viewpoint from which vehicle 4 (see FIG. 1) to be shown by CG image 30B is viewed. At the first viewpoint, a front portion of vehicle 4 is viewed externally from above. At the second viewpoint, the central rearward area relative to vehicle 4 is viewed horizontally through a rear-view mirror from the driver's seat of vehicle 4. More specifically, if a predetermined condition is met, CG generator 26B generates CG image 30B in which the virtual viewpoint changes from the first viewpoint to the second viewpoint with elapse of time.

It should be noted that in Embodiment 3, the virtual viewpoint changes from the first viewpoint to the second viewpoint. However, this is a mere example. The virtual viewpoint may be set to a given viewpoint between the first viewpoint and the second viewpoint, for example, by the driver operating the operation switch described above.

### [3-2. Operation of Image Synthesis Apparatus]

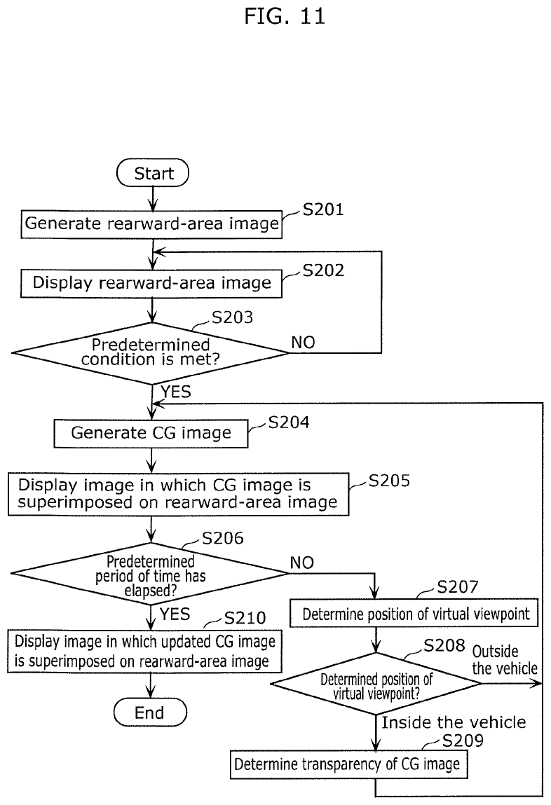

With reference to FIGS. 11 and 12, operation of image synthesis apparatus 2B according to Embodiment 3 is described. FIG. 11 is a flowchart illustrating a procedure of operation of image synthesis apparatus 2B according to Embodiment 3. FIG. 12 illustrates examples of superimposed images 32B according to Embodiment 3.

As illustrated in FIG. 11, synthesizer 24 of image synthesizer 22B generates rearward-area image 20 (S201) and outputs generated rearward-area image 20 to superimposer 28. Superimposer 28 outputs rearward-area image 20 output by synthesizer 24 to display 12. This enables display 12 to display rearward-area image 20 output by superimposer 28 (S202). Here, CG image 30B is yet to be superimposed on rearward-area image 20 displayed on display 12.

CG generator 26B then determines whether a predetermined condition is met (S203). When the predetermined condition is not met (No in S203), the procedure returns to step S202, and display 12 continues to display rearward-area image 20 output by superimposer 28.

When the predetermined condition is met (Yes in S203), CG generator 26B generates CG image 30B (S204) and outputs generated CG image 30B to superimposer 28. Superimposer 28 generates superimposed image 32B by superimposing CG image 30B output by CG generator 26B on rearward-area image 20 output by synthesizer 24 and then outputs generated superimposed image 32B to display 12. This enables display 12 to display superimposed image 32B output by superimposer 28 (S205).

As illustrated in (a) in FIG. 12, the virtual viewpoint for CG image 30B immediately after the predetermined condition is met corresponds to the first viewpoint at which the front portion of vehicle 4 is viewed externally from above. That is, CG image 30B shows the appearance of the front portion of vehicle 4 drawn based on the first viewpoint. The whole of CG image 30B is opaque with, for example, a transparency of 0%. Thus, in superimposed image 32B, it is not possible to visually recognize the part of rearward-area image 20 on which CG image 30B is superimposed. By viewing CG image 30B superimposed on rearward-area image 20, a driver can readily recognize the positional relationship between vehicle 4 and the rearward area relative to vehicle 4 that appears in rearward-area image 20.

When a predetermined period of time has not elapsed since the predetermined condition was met (No in S206), CG generator 26B determines that the virtual viewpoint for CG image 30B corresponds to a third viewpoint between the first viewpoint and the second viewpoint (S207). At the third viewpoint, the front portion of vehicle 4 is viewed externally from above with a smaller angle of depression than the first viewpoint. If the determined virtual viewpoint is outside the vehicle (outside the vehicle in S208), the procedure returns to step S204. CG generator 26B generates CG image 30B according to the determined position of the virtual viewpoint and outputs generated CG image 30B to superimposer 28. Superimposer 28 generates superimposed image 32B by superimposing CG image 30B output by CG generator 26B on rearward-area image 20 output by synthesizer 24 and then outputs generated superimposed image 32B to display 12. This enables display 12 to display superimposed image 32B output by superimposer 28 (S205).

Here, as illustrated in (b) in FIG. 12, the virtual viewpoint for CG image 30B corresponds to the third viewpoint at which the front portion of vehicle 4 is viewed externally from above with a smaller angle of depression than the first viewpoint. That is, CG image 30B shows the appearance of the front portion of vehicle 4 drawn based on the third viewpoint. The whole of CG image 30B is opaque with, for example, a transparency of 0%.

When the predetermined period of time has not elapsed since the predetermined condition was met (No in S206), CG generator 26B determines that the virtual viewpoint for CG image 30B corresponds to a fourth viewpoint between the third viewpoint and the second viewpoint (S207). At the fourth viewpoint, the front portion of vehicle 4 is viewed externally in the horizontal direction. If the determined virtual viewpoint is outside the vehicle (outside the vehicle in S208), the procedure returns to step S204. CG generator 26B generates CG image 30B according to the determined position of the virtual viewpoint and outputs generated CG image 30B to superimposer 28. Superimposer 28 generates superimposed image 32B by superimposing CG image 30B output by CG generator 26B on rearward-area image 20 output by synthesizer 24 and then outputs generated superimposed image 32B to display 12. This enables display 12 to display superimposed image 32B output by superimposer 28 (S205).

Here, as illustrated in (c) in FIG. 12, the virtual viewpoint for CG image 30B corresponds to the fourth viewpoint at which the front portion of vehicle 4 is viewed externally in the horizontal direction. That is, CG image 30B shows the appearance of the front portion of vehicle 4 drawn based on the fourth viewpoint. The whole of CG image 30B is opaque with, for example, a transparency of 0%.

When the predetermined period of time has not elapsed since the predetermined condition was met (No in S206), CG generator 26B determines that the virtual viewpoint for CG image 30B corresponds to the second viewpoint at which the central rearward area relative to vehicle 4 is viewed horizontally through the rear-view mirror from the driver's seat of vehicle 4 (S207). If the determined virtual viewpoint is inside the vehicle (inside the vehicle in S208), CG generator 26B obtains the transparency of CG image 30B (S209). Specifically, CG generator 26B determines that the whole of CG image 30B has a transparency of 0%.

The procedure then returns to step S204, and CG generator 26B generates CG image 30B according to the determined transparency and outputs generated CG image 30B to superimposer 28. Superimposer 28 generates superimposed image 32B by superimposing CG image 30B output by CG generator 26B on rearward-area image 20 output by synthesizer 24 and then outputs generated superimposed image 32B to display 12. This enables display 12 to display superimposed image 32B output by superimposer 28 (S205).

Here, as illustrated in (d) in FIG. 12, the virtual viewpoint for CG image 30B corresponds to the second viewpoint at which the central rearward area relative to vehicle 4 is viewed horizontally through the rear-view mirror from the driver's seat of vehicle 4. That is, CG image 30B shows the interior of vehicle 4 drawn based on the second viewpoint. The whole of CG image 30B is opaque with, for example, a transparency of 0%.

When the predetermined period of time has not elapsed since the predetermined condition was met (No in S206), CG generator 26B determines that the virtual viewpoint for CG image 30B corresponds to the second viewpoint (S207). If the determined virtual viewpoint is inside the vehicle (inside the vehicle in S208), CG generator 26B obtains the transparency of CG image 30B (S209). Specifically, CG generator 26B increases the transparency of the part of CG image 30B other than CG image 30a of rear seats to exceed a transparency of 0%, the part including CG images 30b, 30c, and 30d.

The procedure then returns to step S204, and CG generator 26B generates CG image 30B according to the changed transparency and outputs generated CG image 30B to superimposer 28. Superimposer 28 generates superimposed image 32B by superimposing CG image 30B output by CG generator 26B on rearward-area image 20 output by synthesizer 24 and then outputs generated superimposed image 32B to display 12. This enables display 12 to display superimposed image 32B output by superimposer 28 (S205).

Here, as illustrated in (e) in FIG. 12, CG image 30a of the rear seats, which is a part of CG image 30B, is still opaque with a transparency of 0%. The parts of CG image 30B other than CG image 30a of the rear seats, such as CG images 30b, 30c, and 30d, are, on the other hand, translucent with, for example, a transparency of 10%. Thus, in superimposed image 32B, it is possible to visually recognize the parts of rearward-area image 20 on which CG images 30b, 30c, and 30d and others are superimposed.

When the predetermined period of time has not elapsed since the predetermined condition was met (No in S206), each processing of steps S207, S208, S209, S204, and S205 described above is performed again. The foregoing processing is repeated until the predetermined period of time has elapsed since the predetermined condition was met. Thus, while maintaining a transparency of 0% for CG image 30a of the rear seats, CG generator 26B increases the transparency of the part of CG image 30B other than CG image 30a of the rear seats from 0% to 100% as time elapses, the part including CG images 30b, 30c, and 30d.

When the predetermined period of time has elapsed since the predetermined condition was met (Yes in S206), CG generator 26B stops changing the transparency of the part of CG image 30B that is the part other than CG image 30a of the rear seats and that includes CG images 30b, 30c, and 30d and maintains the transparency immediately before changing of the transparency is stopped (e.g., a transparency of 100%).

CG generator 26B outputs to superimposer 28 CG image 30B having the transparency immediately before changing of the transparency is stopped. Superimposer 28 generates superimposed image 32B by superimposing CG image 30B output by CG generator 26B on rearward-area image 20 output by synthesizer 24 and then outputs generated superimposed image 32B to display 12. This enables display 12 to display superimposed image 32B output by superimposer 28 (S210).

As illustrated in FIG. (f) in 12, CG image 30a of the rear seats, which is a part of CG image 30B, is opaque with a transparency of 0%. The parts of CG image 30B other than CG image 30a of the rear seats, such as CG images 30b, 30c, and 30d, are, on the other hand, transparent with a transparency of 100%. Thus, in superimposed image 32B, it is possible to visually recognize the parts of rearward-area image 20 on which CG images 30b, 30c, and 30C and others are superimposed.

This can suppress CG image 30B from obstructing the driver's view of rearward-area image 20, which can enhance the visibility of rearward-area image 20. In addition, among the parts of CG image 30B, for instance, only CG image 30a of the rear seats is opaque. Thus, by viewing CG image 30a of the rear seats superimposed on rearward-area image 20, the driver can readily recognize the positional relationship between vehicle 4 and the rearward area relative to vehicle 4 that appears in rearward-area image 20.

It should be noted that in (f) in FIG. 12, CG image 30a of the rear seats is lower than superimposed CG images 30a in (d) and (e) in FIG. 12. The reason is explained in Embodiment 1 with reference to (c) in FIG. 5.

### [3-3. Advantageous Effects]

In Embodiment 3, as with Embodiment 1, it is possible to enhance the visibility of rearward-area image 20 while CG image 30B displayed on superimposed image 32B enables the driver to recognize the positional relationship between vehicle 4 and the rearward area relative to vehicle 4 that appears in rearward-area image 20.

It should be noted that as with FIG. 5 in Embodiment 1, rearward-area image 20 in FIG. 12 illustrates a case in which vehicle 4 is stationary. However, display control for CG image 30B may be performed when vehicle 4 is traveling. In this case, rearward-area image 20 changes in real time also when display control for CG image 30B is being performed.

### Other Variations

Although an image synthesis apparatus according to one or more than one embodiment is described on the basis of Embodiments 1 to 3, the present disclosure is not limited to the descriptions in Embodiments 1 to 3. Without departing from the spirit of the present disclosure, one or more than one embodiment may cover an embodiment obtained by making various changes envisioned by those skilled in the art to the above embodiments or an embodiment obtained by combining structural elements in different embodiments.

In Embodiments 1 to 3, CG generator 26 (26A, 26B) increases the transparency of a part of CG image 30 (30A, 30B). However, this is a mere example, and CG generator 26 (26A, 26B) may increase the transparency of the whole of CG image 30 (30A, 30B). In this case, at the point in time when a predetermined period of time has elapsed since a predetermined condition was met, the transparency of the whole of CG image 30 (30A, 30B) may be set to a transparency level lower than a transparency of 100% (e.g., a transparency of 80%) to enable a driver to recognize the positional relationship between vehicle 4 and the rearward area relative to vehicle 4 that appears in rearward-area image 20.

It should be noted that in Embodiments 1 to 3, each structural element may be dedicated hardware or be caused to function by running a software program suitable for the structural element. To cause each structural element to function, a program running unit, such as a CUP or processor, may read and run the software program stored in a recording medium, such as a hard disk or semiconductor memory.

A processor, such as a CPU, may run a program (programs) to obtain a part or the whole of the functions of the image synthesis apparatuses according to Embodiments 1 to 3.

A part of the structural elements or every structural element of each image synthesis apparatus described above may be an IC card or single module attachable to and detachable from the apparatus. The IC card or module is a computer system including, for example, a microprocessor, ROM, and RAM. The IC card or module may include the super-multi-function LSI. The IC card or module is caused to function by the microprocessor operating according to a computer program. The IC card or module may be tamper-resistant.

The present disclosure may be the methods described above. In addition, the present disclosure may be a computer program to be run on a computer to implement the methods or a digital signal incorporating the computer program. The present disclosure may be the computer program or digital signal stored in a computer-readable recording medium, such as a flexible disk, a hard disk, CD-ROM, an MO disk, DVD-ROM, DVD-RAM, a Blu-ray (registered trademark) Disc (BD), and semiconductor memory. The present disclosure may be the digital signal stored in such a recording medium. In the present disclosure, the computer program or digital signal may be transmitted via, for example, an electrical communication line, wireless or wired communication line, network (a typical example is the Internet), or data broadcasting. The present disclosure may be a computer system including a microprocessor and memory. The memory may store the computer program, and the microprocessor may operate according to the computer program. Another computer independent of the above computer may perform processing by receiving the computer program or digital signal stored in the recording medium or by receiving the computer program or digital signal via, for example, the network.

While various embodiments have been described herein above, it is to be appreciated that various changes in form and detail may be made without departing from the spirit and scope of the present disclosure as presently or hereafter claimed.

Further Information about Technical Background to this Application

The disclosures of the following Japanese Patent Applications including specification, drawings and claims are incorporated herein by reference in their entirety: Japanese Patent Application No. 2020-040749 filed on Mar. 10, 2020 and Japanese Patent Application No. 2020-149525 filed on Sep. 7, 2020.

### INDUSTRIAL APPLICABILITY

The image synthesis apparatuses according to the present disclosure are applicable to, for example, the electronic mirror of a vehicle.

1. An image synthesis apparatus, comprising:
a rearward camera for capturing a central rearward area relative to a vehicle;
a left camera for capturing a left rearward area relative to the vehicle;
a right camera for capturing a right rearward area relative to the vehicle; and
an image synthesizer that synthesizes a central-rearward-area image captured by the rearward camera, a left-rearward-area image captured by the left camera, and a right-rearward-area image captured by the right camera to generate a rearward-area image showing a whole of the central, left, and right rearward areas relative to the vehicle,
wherein when a predetermined condition is met, the image synthesizer further generates a superimposed image in which a computer graphics (CG) image showing the vehicle is superimposed on the rearward-area image and increases transparency of at least a part of the CG image as time elapses.

2. The image synthesis apparatus according to claim 1,
wherein the predetermined condition is at least one of the following conditions: that an ignition switch of the vehicle is switched on, that an operation switch of the vehicle receives an instruction from a user to display the superimposed image on a display, and that the vehicle in a stationary state starts moving.

3. The image synthesis apparatus according to claim 1,
wherein when a predetermined period of time has elapsed since the predetermined condition was met, the image synthesizer stops changing the transparency of the at least a part of the CG image.

4. The image synthesis apparatus according to claim 3,
wherein the predetermined period of time is settable by a user.

5. The image synthesis apparatus according to claim 3,
wherein the transparency of the at least a part of the CG image is settable by a user, the transparency being transparency when the predetermined period of time has elapsed since the predetermined condition was met.

6. The image synthesis apparatus according to claim 1,
wherein the image synthesizer is capable of changing a virtual viewpoint between a first viewpoint and a second viewpoint and generates the CG image based on the virtual viewpoint, the virtual viewpoint being a viewpoint from which the vehicle to be shown by the CG image is viewed, the first viewpoint being a viewpoint at which a front portion of the vehicle is viewed externally from above, and the second viewpoint being a viewpoint at which an area behind the vehicle is viewed horizontally from a driver's seat of the vehicle.

7. The image synthesis apparatus according to claim 6,
wherein when the predetermined condition is met, the image synthesizer superimposes the CG image on the rearward-area image while changing the virtual viewpoint from the first viewpoint to the second viewpoint with elapse of time to generate the superimposed image.

8. The image synthesis apparatus according to claim 6,
wherein the virtual viewpoint is settable by a user.

9. The image synthesis apparatus according to claim 1,
wherein the predetermined condition is that a traveling object does not appear in the rearward-area image or that the vehicle is stationary and a stationary object does not appear in the rearward-area image.

10. The image synthesis apparatus according to claim 1,
wherein if a traveling object appears in the rearward-area image, the image synthesizer detects a position and a size of the object, removes or simplifies a part of the CG image in the superimposed image, and superimposes the CG image that has been partially removed or simplified on the rearward-area image, the part of the CG image being located at the position of the object and having a size equivalent to at least the size of the object.

11. The image synthesis apparatus according to claim 1,
wherein during operation of a direction indicator of the vehicle, the image synthesizer superimposes, on the rearward-area image, at least one of two halves of the CG image split by a center line in a transverse direction of the CG image, the one of the two halves corresponding to a direction opposite to a direction indicated by the direction indicator.
